(19) United States
(12) Patent Application Publication
(10) Pub. No.: US 2015/0096620 A1
(43) Pub. Date: Apr. 9, 2015

(54) OIL-LESS PUMP SAMPLING SYSTEM AND METHOD

(71) Applicant: UMM-AL-QURA UNIVERSITY, MAKKAH (SA)

(72) Inventor: ATEF MOHAMED FATHY MOHAMED, MAKKAH (SA)

(73) Assignee: UMM-AL-QURA UNIVERSITY, MAKKAH (SA)

(21) Appl. No.: 14/047,952

(22) Filed: Oct. 7, 2013

(51) Int. Cl. G01N 1/14; G01N 1/24

(52) U.S. Cl. CPC G01N 1/14; G01N 1/24
USPC 137/1; 137/565.17

(57) ABSTRACT

An oil-less pump sampling system for portable environmental testing. The system includes an oil-less pump that generates a suctioning force, an external hose carrying the suction from the pump and in fluid communication with a control value and a collection container. The control valve is fluidly connected to the external hose to regulate the flow of suction, and the collection container is fluidly connected to the external hose for suctioning a sample from the surrounding environment. The internal assembly of the pump includes an electromagnetic coil generating an electromagnetic force to move a plurality of magnets. The magnets oscillate to move a plurality of lever arms which move a plurality of diaphragms to create the suction force from a valve block. A plurality of internal hoses stems from the valve block and joined at a connector to carry the suctioning force to the external hose.

### BACKGROUND OF THE INVENTION

1. Field of the Invention

The present invention relates to environmental quality, and particularly to an oil-less pump sampling system that allows for the collection of contaminated fluid from an environment.

2. Description of the Related Art

Environmental quality is a top priority for all nations because of the dangers pollution presents. Crops, fresh and salt water, humans, animals, and even buildings can all be damaged by pollution. To track and combat these dangers regular environmental testing must be implemented. Many different forms of environmental testing exist, but typical testing, especially for air quality, involves an active sampling system employing a vacuum pump. Active sampling is when a sample is collected from the surrounding environment and placed into a collection medium.

The vacuum pumps used in active sampling systems can be generally broken down into two categories; oil-less and oil-lubricated. Oil-less pumps can offer numerous advantages over oil-lubricated pumps. Oil-less pumps typically don't require frequent maintenance, since oil does not need to be replaced. Also, oil-less pumps are usually of a lighter weight allowing them to be hung in various orientations due to the lack of oil in the pump. Finally, oil-less pumps can eliminate a danger of oil contamination. This feature can be especially crucial when testing for air quality, because any type of oil contamination could provide a false reading of the collected sample.

However, in a cost comparison, oil-less pumps are typically more costly compared to oil-lubricated pumps. Typical price differences between comparable oil-less pumps and oil-lubricated pumps can range from several hundred to several thousands of dollars, for example. Further, most oil-less pumps typically use complex mechanics to compensate for the lack of oil-lubrication. As such these complex systems can wear out easier and can be louder during operation.

Therefore, it is desirable that an oil-less pump sampling system be more affordable, have greater longevity, and be quieter during operation.

Thus, an oil-less pump sampling system for the collection of environmental samples addressing the aforementioned problems is desired.

### SUMMARY OF THE INVENTION

Embodiments of oil-less pump sampling systems and methods allow for portable environmental testing without the disadvantages of using an oil-lubricated vacuum pump. The oil-less pump sampling systems and methods take a sample of fluid from the surrounding environment by suction and contain it for later analysis. The types of environmental samples of fluid that are taken can include interior and exterior air samples, saltwater, fresh water, soil and any other common environmental substance as a sample.

The oil-less pump sampling systems and methods employ an oil-less vacuum pump to generate a suctioning force. An external hose, such as a pneumatic hose, carries the suctioning force from the pump to a collection container. A control valve in communication with the external hose regulates the flow of suction to and from the container. A seal placed around the aperture of the container provides a controlled place for the sample to be taken and stored.

These and other features of the present invention will become readily apparent upon further review of the following specification and drawings.

### BRIEF DESCRIPTION OF THE DRAWINGS

FIG. 1 is an environmental view of an embodiment of an oil-less pump sampling system according to the present invention.

FIG. 2 is a perspective view of a collection container of an oil-less pump sampling system according to the present invention.

FIG. 3 is a perspective view of the internal assembly of a prior art aquarium air pump.

FIG. 4 is a perspective view of an unassembled valve block of embodiments of an oil-less pump sampling system according to the present invention.

FIG. 5 is a perspective view of a valve block assembly of embodiments of an oil-less pump sampling system according to the present invention.

FIG. 6 is a perspective view of the internal assembly of an oil-less pump of embodiments of an oil-less pump sampling system according to the present invention.

Unless otherwise indicated, similar reference characters denote corresponding features consistently throughout the attached drawings.

### DETAILED DESCRIPTION OF THE PREFERRED EMBODIMENTS

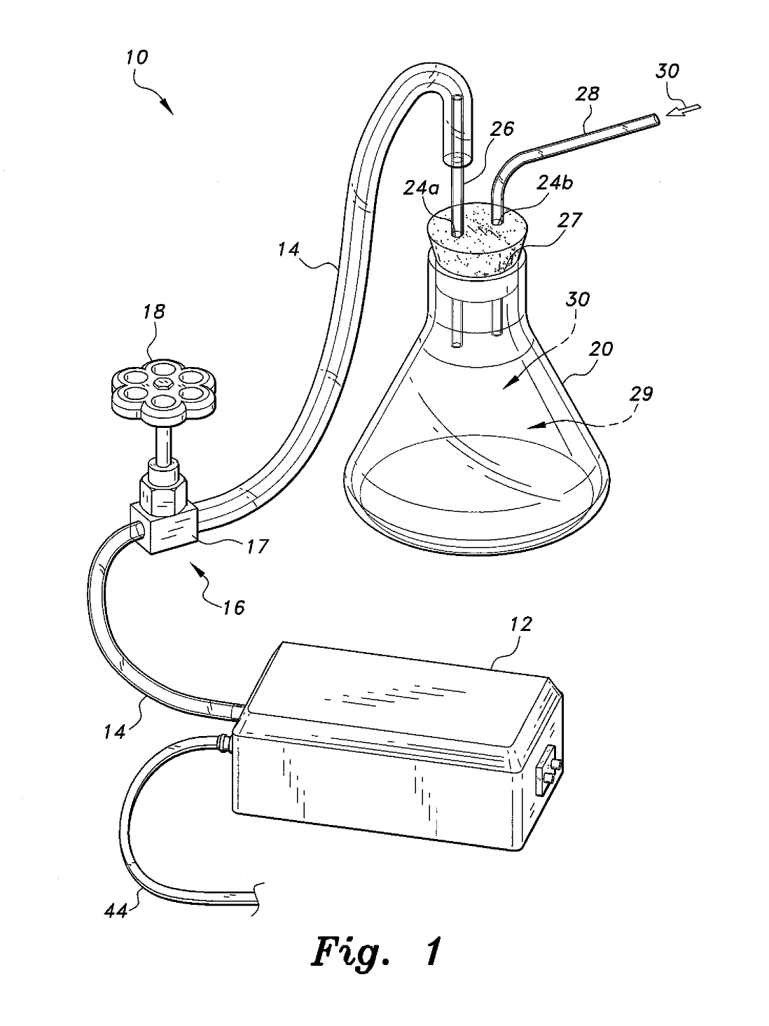

Referring to FIG. 1, an embodiment of an oil-less pump sampling system 10 to collect fluid samples 30, such as to test the samples for environmental quality, is shown. The sampling system 10 is placed into a setting to collect the fluid samples 30, such as may include contaminates, particulates or other material, and therefore may be collected, such as for testing or other analysis. The fluid samples 30 can include volatile organic compounds, gaseous pollutants, respiratory and fine particulate matter, and other common forms of pollution. The setting or environment where the oil-less pump sampling system 10 is placed can be in the interior of a building to collect samples of indoor air, the exterior of a building to collect samples of ambient air, a small body of water to collect samples of fresh or salt water, or any other similar setting to collect samples for environmental or other testing, for example.

Continuing with reference to FIGS. 1-5, the sampling system 10 collects the fluid sample 30 from the surrounding setting or environment by the action of a suctioning force generated from the oil-less pump 12. The suction force that is developed by the pump 12 is carried through a first elongated external hose 14 that is attached internally to the pump 12 on one end. The external hose 14 can be a pneumatic hose, or other tube or conveying member, to convey a fluid, such as air, or can be a hose, tube or conveying member to convey other fluids in the sampling system 10, to carry the suction force, for example. The external hose 14 travels or extends from the pump 12 to a control valve 16, where the suctioning force is regulated. The control valve 16 can be a number of different common valves, such as a ball valve, but should not be construed in a limiting sense. The external hose 14 and the control valve 16 are fluidly connected to allow the suctioning force to flow through the valve body 17. The external hose can be formed integrally with the control valve 16 or the external hose 14 can include a plurality of hoses or hose sections fluidly connected, for example. The flow through of the suctioning force is controlled by a control member 18 associated with the control valve 16, such as wheel-type controller associated with the control valve 16, that when moved to an open position, such as a position between the fully open position and a fully closed position, permits the suctioning force to flow through the valve body 17. When the control member 18 is placed into a fully closed position the suctioning force is prohibited from flowing through the valve body 17 and the suctioning force is prohibited from moving through the sampling system 10. The control member 18 can be any suitable control member and should not be construed in a limiting sense.

When the control valve 16 is in the open position the suctioning force continues to travel or be carried along the external hose 14 where it will be carried to a collection container 20. The suctioning force will flow through the collection container 20 to allow for the fluid sample 30 to be suctioned into the collection container 20. The collection container 20 provides a receptacle that serves as a controlled place for the fluid sample 30 to be taken and stored until testing or other analysis can be performed on the fluid sample 30.

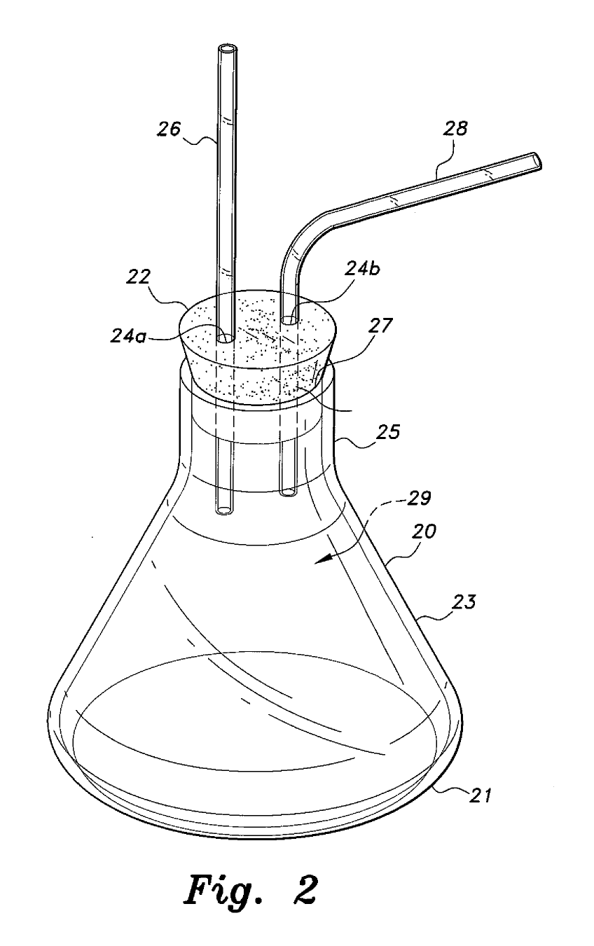

Referring to FIG. 2, an embodiment of a collection setup of the sampling system 10 is shown, for example. The collection set up includes the collection container 20 which can take a number of suitable forms, including a cuvette, a Buchner flask, or an Erlenmeyer flask, among others, depending upon the use or application, and therefore, should not be construed in a limiting sense. As shown in FIG. 2 the collection container 20 can be of a generally conical shape, with a generally flat bottom 21, a generally conical-shaped body 23, and a generally cylindrical neck 25. At the top of the cylindrical neck 25 is an aperture 27 that permits access to the interior 29 of the conical-shaped body 23. A sealing member 22 is placed about the aperture 27 thereby creating a sealed environment within the collection container 20 for the collected fluid sample 30.

The sealing member 22, can be any of suitable types, and is typically rigid enough to take a generally solid form but also flexible enough to fit within the aperture 27 to create a sealed environment within the collection container 20, for example. The sealing member 22 has a plurality of channels, such as a first channel 24a and a second channel 24b that provide a pathway for the suctioning force to enter the sealed environment and to also allow the fluid sample 30 to enter into the collection container 30. In the first channel 24a of the sealing member 22 the external hose 14 is communicatively connected, such as by or via a tube 26, which is inserted through the first channel 24a of the sealing member 22. This communicating tube 26 can be rigid or flexible depending on the particular use or application, and should not be construed in a limiting sense. It should be also noted that the communicating tube 26 can be removed and the external hose 14 can be connected directly to the first channel 24a of the sealing member 22, as may reduce a total cost of the sampling system 10. The second channel 24b of the sealing member 22 can hold a second tube 28 to communicate the interior 29 of the collection container 20 with the surrounding environment that includes the fluid sample 30 to be collected. This second tube 28 can also be rigid or flexible once again depending on the particular use or application, and should not be construed in a limiting sense. This second tube 28 acts as a gateway for the fluid sample 30 to be suctioned from the outside environment and placed within the interior 29 of the sealed collection container 30.

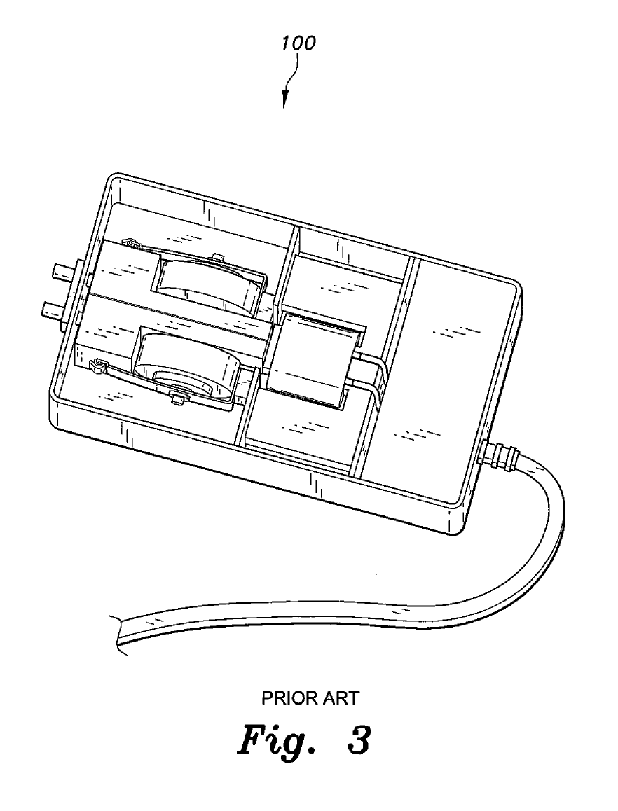

Referring to FIG. 3, a prior art aquarium pump 100 is shown. Aquarium pumps are known in the art for generating a blowing force that when used in combination with a fish aquarium will create air bubbles in the aquarium water, and such pumps typically do not generate a suctioning force. An example of such a known aquarium or fish tank pump is a Heto, SK-9850 pump; having a power of 4.5 Watts (W) and a pressure of 0.018 Megapascals (MPa) and an exhaust amount of about 2.4 liters (L)/minute, for example. However, an aquarium pump, such as the Heto, SK-9850 pump, may be modified to include various novel features of the pump 12, as discussed and described, as may be used in the sampling system 10.

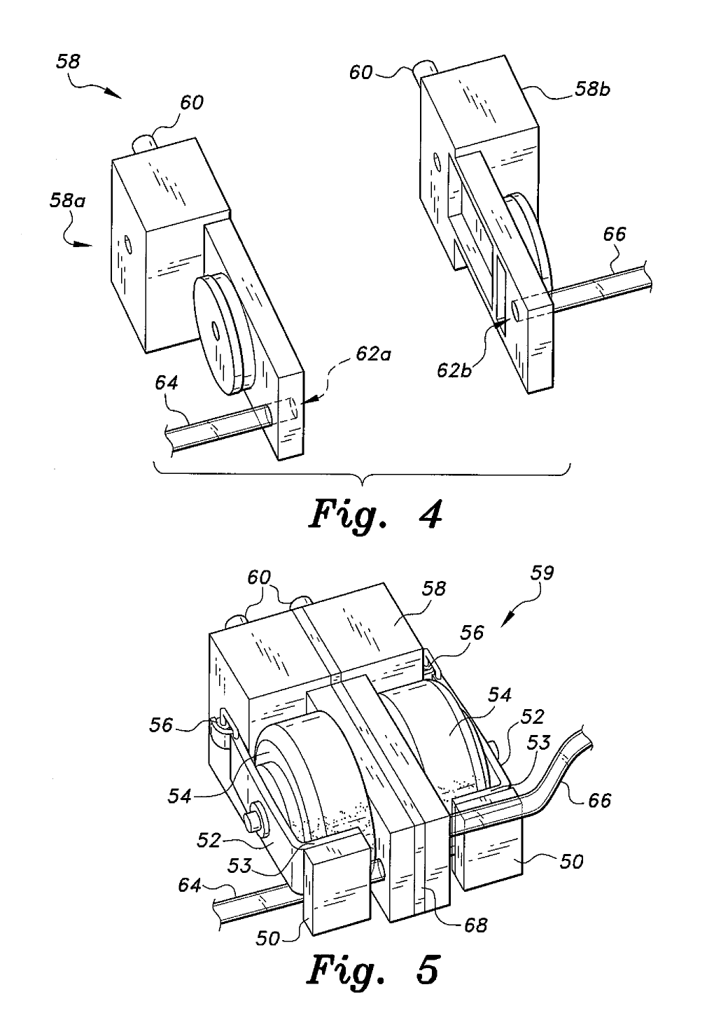

Referring to FIG. 4, a valve block 58 of the pump 12 is illustrated that is used in generating the applied suction force to collect the fluid sample 30 in the system 10. The valve block 58 can include a first section 58a and a second section 58b, which can be separately or integrally formed, for example. The valve block 58 includes a plurality of openings 62, such as pair of a first valve block opening 62a and a second valve block opening 62b in a region where the suction is generated through the valve block 58. The valve block 58 can also include outlets 60 as may pass through a fluid, such as air, in generating the suction. A first internal hose 64 is fluidly connected to the first valve block opening 62a and a second internal hose 66 is fluidly connected to the second valve block opening 62b. The first and second internal hoses 64 and 66 carry the suctioning force produced through the valve block 58 out to the external hose 14.

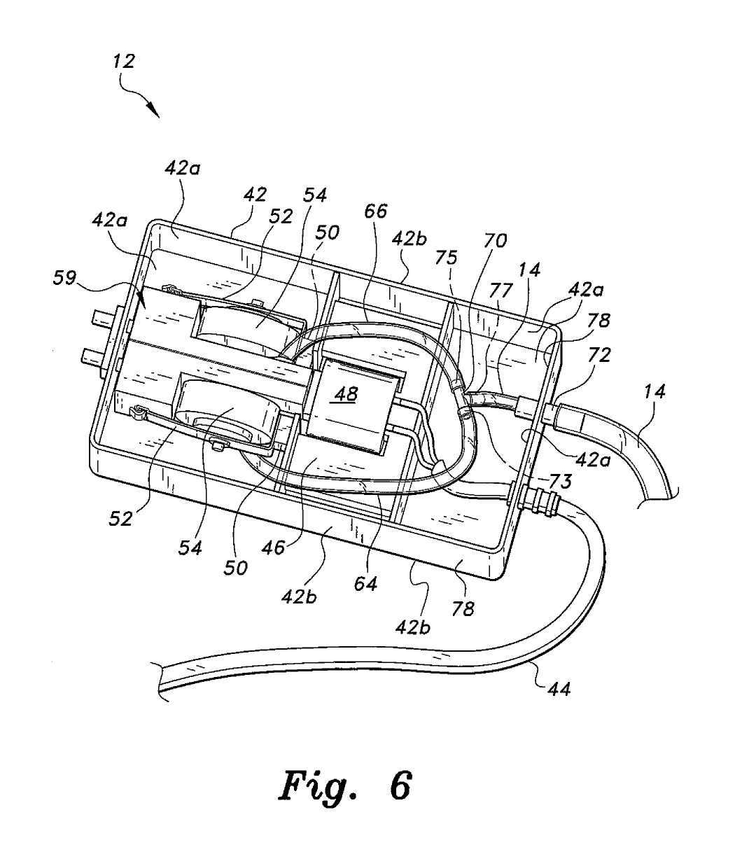

Referring to FIGS. 5 and 6, an internal assembly of the oil-less vacuum pump 12 including a valve block assembly 59 of the pump 12 is shown. The sections of the valve block 58 shown in FIG. 4 are now joined together, by a suitable material 68, such as by a combination of rubber and silicone wax. The valve block assembly 59 includes a plurality of lever arms 52 that serve to move a plurality of diaphragms 54. The diaphragms 54 are respectively attached to the lever arms 52 and typically are flexible and have a concave interior. The flexibility of the diaphragms 54 allows for contraction and expansion of the diaphragms 54 when moved by the respective lever arms 52. The lever arms 52 are pivotally attached at their rear end to the valve body 58, such as via a pivot 56. At the front end of the lever arms 52 exists a platform 53 where a plurality of magnets 50 rest.

The magnets 50, the lever arms 52, and the diaphragms 54 work in cooperation to generate the suctioning force. An electromagnetic coil 48 in the pump 12 generates an electromagnetic force. The electromagnetic force repels and attracts the magnets 50 respectively situated on the lever arms 52, causing the lever arms 52 to oscillate, the magnets 50 being in electromagnetic communication with the electromagnetic coil 48. The oscillation movement of the level arms 52 causes the plurality of diaphragms 54 to respectively expand and compress or contract.

The movement of the diaphragms 54 generates the suction force, which is then carried away from the valve block 58 by the first internal hose 64 through the fluid connection to the first valve block opening 62a and through the second internal hose 66 through the fluid connection to the second valve block opening 62b. The first and second internal hoses 64 and 66 are joined through a multi-port connector 70, or other suitable connector, to create a unitary combined suctioning force. The multi-port connector 70 is fluidly connected to the external hose 14. The unitary combined suctioning force is then carried from the pump 12 through the multi-port connector 70 by the external hose 14 to the collection container 20, as discussed.

The pairing of the first and second internal hoses 64 and 66 through the multi-port connector 70 enables a relatively stronger and relatively streamlined suction force. In this regard, each of the first and second internal hoses 64 and 66 has been measured individually to have a flow rate of about 4.5 liters per minute. By joining the first and second internal hoses 64 and 66 through the multi-port connector 70, or other suitable connector, the two internal hoses 64 and 66 together at the multi-port connector can enable the flow rate to be increased to about 8-9 liters per minute. The multi-port connector as shown in FIG. 6 is in the shape of a T-connector, for example, and can have two inlet ports, a first inlet port 73 and a second inlet port 75 and an outlet port 77. The first internal hose 64 is fluidly connected to the first inlet port 73 and the second internal hose 66 is fluidly connected to the second inlet port 75, and the external hose 14, communicatively connected to the pump 12 and to the collection container 20, is fluidly connected to the outlet port 77. Depending on the testing or analysis requirements or application, any of various types of multi-port connectors can be used to increase the number of inlet ports or outlet ports, and should not be construed in a limiting sense.

As shown in FIG. 6, the external hose 14 fluidly communicates with the multi-port connector 70 through a portal 72 in a housing 42 of the pump 12. The portal 72 serves to communicate the suction generated inside the pump 12 to the external hose 14 and to the outside of the pump 12.

Continuing with reference to FIG. 6, the housing 42 of the pump 12 can be made from a number of different materials, including water resistant or weather resistant materials depending upon the use and application, for example, and should not be construed in a limiting sense. When water resistant materials are used for the housing 42, the sampling system 10 including the pump 12 can be placed outdoors and can operate in various types of inclement weather, such as rain or snow, for example. Further, the housing 42 can be insulated on one or more of interior surfaces 42a or exterior surfaces 42b of the housing 42 with a sound-dampening material 78 which can also be a weather resistant material, such as rubber. Rubber insulation can act as a sound dampener for a relatively quieter operation of the pump 12. If rubber is placed onto one or more of the exterior surfaces 42b of the housing 42, the pump 12 can also be relatively more resistant to bumps and jarring, as well as provide for water or weather resistance, for example.

A power cord 44 provides electrical power from a power source to the electromagnetic coil 48 of the oil-less vacuum pump 12 during operation. The power cord 44 can be plugged into any standard wall outlet, or connect to other suitable power source, such as a battery. The pump can also be powered by battery, dependent on the location and application, and the battery can also be provided as a part of the pump 12, for example. A platform 46 located within the housing 42 positions the electromagnetic coil 48 within the housing 42.

Embodiments of the sampling system including an oil-less pump, as discussed, can provide many benefits over an oil-lubricated pump. The oil-less pump can provide a relatively quieter operation over an oil-lubricated pump in that it can use an electromagnetic coil, magnets, and diaphragms to generate a suctioning force. Also, a relatively quieter operation of the oil-less pump can be enhanced by placing a sound-dampening material, such as a rubber material, on the exterior or interior surfaces of the pump housing, which can reduce vibration during operation of the pump. Further, use of the rubber-like material on exterior surfaces of the housing can enhance the use of the pump in inclement weather or in various outdoor environments, for example.

As discussed, there are many benefits to using various embodiments of a sampling system including an oil-less pump. Oil-lubrication is not needed, which can reduce the possibility of accidental contamination. Also, relatively fewer parts are typically involved with the oil-less pump, which can simplify repairs and can increase the longevity of the pump. Further, relatively fewer components can provide for a relatively lighter pump for use in different applications, such as one that calls for the pump to be hung onto an interior wall. Finally, since the various components of the oil-less pump are moved by oscillation and sliding, relatively less energy can be required to generate the suction in comparison to an oil-lubricated pump, which can enhance reduced power consumption.

It is to be understood that the present invention is not limited to the embodiments described above, but encompasses any and all embodiments within the scope of the following claims.

I claim:

1. An oil-less pump sampling system, comprising:
an oil-less pump to suction a fluid from an environment;
an external hose fluidly connected to the oil-less pump;
a control valve fluidly connected to the oil-less pump and to the external hose, the control valve including a control member to control the suction flow through the external hose;
a collection container, the collection container to collect a fluid sample of the fluid by s the suction generated from the oil-less pump; and
a sealing member disposed about an aperture of the collection container, the sealing member to seal the aperture of the collection container from the environment, the sealing member having a plurality of channels to provide a pathway for the fluid sample into the collection container;
wherein a first channel of the plurality of channels is communicatively connected to the external hose, and a second channel of the plurality of channels receives the fluid sample from the environment.

2. The oil-less pump sampling system according to claim 1, further comprising:
a housing, the housing enclosing said oil-less pump;
an electromagnetic coil to generate an electromagnetic force, the electromagnetic coil positioned within the housing;
a plurality of magnets, the magnets in electric-magnetic communication with the electromagnetic coil;
a plurality of lever arms, the lever arms in communication with the magnets;
at least one pair of opposing diaphragms associated with the lever arms, the diaphragms being moved by the lever arms to generate the suction by application of the electromagnetic force; and
a valve block, the valve block communicating with the at least one pair of diaphragms to output the generated suction from the diaphragms, the valve block having a first opening associated with one of the pair of diaphragms and a second opening associated with the other of the pair of diaphragms to output the generated suction through the first and second openings.

3. The oil-less pump sampling system according to claim 2, further comprising:
a first internal hose, the first internal hose being fluidly connected to the first opening;
a second internal hose, the second internal hose being fluidly connected to the second opening; and
a multi-port connector, the multi-port connector having a first inlet port, a second inlet port, and an outlet port,
wherein the first inlet port is fluidly connected to the first internal hose, the second inlet port is fluidly connected to the second internal hose, and said external hose is fluidly connected to the outlet port.

4. The oil-less pump sampling system according to claim 3, wherein said multi-port connector is a T connector.

5. The oil-less pump sampling system according to claim 3, wherein said first and second internal hoses comprise Silicon.

6. The oil-less pump sampling system according to claim 5, wherein said multi-port connector is a T connector.

7. The oil-less pump sampling system according to claim 3, wherein the external hose is a pneumatic hose and the fluid sample comprises air.

8. The oil-less pump sampling system according to claim 3, wherein the housing is insulated with a sound dampening material.

9. The oil-less pump sampling system according to claim 1, wherein the external hose is a pneumatic hose and the fluid sample comprises air.

10. The oil-less pump sampling system according to claim 1, wherein the housing is insulated with a rubber material.

11. A method for sampling a fluid from an environment using an oil-less pump, comprising the steps of:
fluidly connecting an oil-less pump to an external hose fluidly connected to a control valve, the control valve including a control member to control a suction flow through the external hose;
fluidly connecting a collection container to the external hose, the collection container to collect a fluid sample of a fluid by the suction generated by the oil-less pump;
sealing an aperture of the collection container with a sealing member, the sealing member having a plurality of channels to provide a path for the fluid sample into the collection container; and
applying a suction from the oil-less pump to collect the fluid sample from the environment into the collection container,
wherein a first of the plurality of channels is communicatively connected to the external hose to apply the suction from the oil-less pump to the collection container, and a second of the plurality of channels is communicatively connected to the collection container and to the environment to collect the fluid sample from the environment into the collection container by the applied suction.

12. The method for sampling a fluid according to claim 11, further comprising the steps of:
generating an electromagnetic force by an electromagnetic coil;
receiving the generated electromagnetic force by a plurality of magnets in electric-magnetic communication with the electromagnetic coil;
reciprocating a plurality of lever arms in communication with the magnets by application of the generated electromagnetic force;
moving at least one pair of opposing diaphragms by the reciprocating movement of the lever arms to generate the suction; and
outputting the generated suction from the diaphragms to a valve block having a first opening associated with one of the pair of diaphragms and a second opening associated with the other of the pair of diaphragms; and
outputting the generated suction through the first and second openings.

13. The method for sampling a fluid according to claim 12, further comprising the steps of:
connecting a first internal hose to the first opening of the valve block;
connecting a second internal hose to the second opening of the valve block;
connecting the first internal hose to a first inlet port of a multi-port connector and the second internal hose to a second inlet port of the multi-port connector; and
connecting the external hose to an outlet port of the multi-port connector.

14. The method for sampling a fluid according to claim 13, wherein the fluid sample comprises air and the external hose comprises a pneumatic hose.

15. The method for sampling a fluid according to claim 13, further comprising the step of insulating a housing of the oil-less pump with a sound-dampening material.

16. The method for sampling a fluid according to claim 15, wherein the sound dampening material comprises rubber.

17. The method for sampling a fluid according to claim 11, further comprising the step of insulating a housing of the oil-less pump with a sound dampening and weather-resistant material.

18. The method for sampling a fluid according to claim 17, wherein the sound dampening and weather resistant material comprises rubber.

19. The method for sampling a fluid according to claim 11, wherein the fluid sample comprises air and the external hose is a pneumatic hose.

20. The method for sampling a fluid according to claim 11, further comprising the step of insulating a housing of the oil-less pump with rubber.
